(19) United States
(12) Patent Application Publication
(10) Pub. No.: US 2026/0335817 A1
(43) Pub. Date: Oct. 29, 2026

(54) SYSTEMS AND METHODS FOR PROCESSING GASES

(71) Applicant: NET Power LLC, Durham, NC (US)

(72) Inventor: Bin Xu, Houston, TX (US)

(73) Assignee: NET Power LLC, Durham, NC (US)

(21) Appl. No.: 19/350,707

(22) Filed: Oct. 6, 2025

Related U.S. Application Data
(60) Provisional application No. 63/706,546, filed on Oct. 11, 2024.

(51) Int. Cl. B01D 53/26; B01D 53/00

(52) U.S. Cl. CPC B01D 53/265; B01D 53/002; B01D 53/005; B01D 2256/10; B01D 2256/12; B01D 2256/18; B01D 2257/302; B01D 2257/40; B01D 2257/504; B01D 2257/80; B01D 2258/0283

(57) ABSTRACT

Methods and systems for separating components of an air stream are disclosed. Water is condensed out of the air stream against a cryogenic fluid stream in a water separator. Carbon dioxide is condensed against the cryogenic fluid stream in a carbon dioxide separator. The remaining components of the air stream are separated into a nitrogen product stream, an argon product stream, and an oxygen product stream in a cryogenic separator. One or more of the nitrogen product stream, the argon product stream, and the oxygen product stream are used as the cryogenic fluid stream.

### CROSS-REFERENCE TO RELATED APPLICATIONS

This application claims the benefit of U.S. Provisional Patent Application No. 63/706,546, filed Oct. 11, 2024 and entitled “Systems and Methods for Processing Gases,” the entire contents of which are incorporated by reference herein.

### TECHNICAL FIELD

The present disclosure relates to systems and methods for processing gases, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the present disclosure provides a method for separating components of an air stream comprising water, carbon dioxide, nitrogen, argon, and oxygen in an oxy-fuel power generation system. The method includes passing the air stream into an air separation unit with a water separator, a carbon dioxide separator, and a cryogenic separator. The method also includes condensing water out of the air stream against a first cryogenic fluid stream in the water separator, forming a dry air stream and an H2O stream. The method also includes condensing carbon dioxide out of the dry air stream against a second cryogenic fluid stream in the carbon dioxide separator, forming a CO2-barren air stream and a concentrated carbon dioxide stream. The method also includes separating the CO2-barren air stream into a nitrogen product stream, an argon product stream, and an oxygen product stream in the cryogenic separator. The method also includes using one or more of the nitrogen product stream, the argon product stream, and the oxygen product stream as the first cryogenic fluid stream, the second cryogenic fluid stream, or both. In a particular embodiment, the nitrogen product stream, the argon product stream, and/or the oxygen product stream are used as the first cryogenic fluid stream, the second cryogenic fluid stream, or both, after a startup period. The method also includes combusting the oxygen product stream in a combustor of the oxy-fuel power generation system. The method also includes purifying and compressing the concentrated carbon dioxide stream in a carbon dioxide purification and compression unit.

In some examples, the water separator includes a first train and a second train In a particular embodiment, the step of condensing water out of the air stream includes condensing water out of the air stream as a first water ice in the first train; condensing water out of the air stream as a second water ice in the second train; while using the second train to condense water, heating the first train to melt the first water ice to form a first liquid water; draining the first liquid water from the first train; while using the first train to condense water, heating the second train to melt the second water ice to form a second liquid water; and draining the second liquid water from the second train.

In some examples, the carbon dioxide separator includes a first train and a second train. In a particular embodiment, the step of condensing carbon dioxide out of the dry air stream comprises condensing carbon dioxide out of the dry air stream as a first dry ice in the first train; condensing carbon dioxide out of the dry air stream as a second dry ice in the second train; while using the second train to condense carbon dioxide, heating the first train to melt or sublimate the first dry ice to form a first liquid carbon dioxide or a first gaseous carbon dioxide; draining the first liquid carbon dioxide or the first gaseous carbon dioxide from the first train; while using the first train to condense carbon dioxide, heating the second train to melt or sublimate the second dry ice to form a second liquid carbon dioxide or a second gaseous carbon dioxide; and draining the second liquid carbon dioxide or the second gaseous carbon dioxide from the second train.

In some examples, the method further includes adding flue gas from a combustion process to the air stream passing into the air separation unit. In some examples, the method further includes stripping NOx and SOx from the flue gas before adding the flue gas to the air stream. In some examples, the method further includes stripping NOx and SOx from the flue gas via an acid gas stripper, after the step of condensing water out of the air stream and before the step of condensing carbon dioxide out of the dry air stream.

In some examples, during startup of the air separation unit, the method further includes using a cryogenic coolant from a standalone cryogenic unit as the first cryogenic fluid stream, the second cryogenic fluid stream, or both.

In some examples, the method further includes using the H2O stream as cooling water in a power generation system.

In some examples, the method further includes compressing the air stream before the step of condensing water, such that the carbon dioxide condenses as a liquid during the step of condensing carbon dioxide.

In some examples, the method further includes compressing the dry air stream before the step of condensing carbon dioxide, such that the carbon dioxide condenses as a liquid during the step of condensing carbon dioxide.

In some examples, the method further includes compressing the CO2-barren air stream into the cryogenic separator.

In some examples, the method further includes heating the H2O stream with a hot fluid from another process, the concentrated carbon dioxide stream, or both.

In some examples, the method further includes combining a carbon dioxide discharge product of the combustor with the concentrated carbon dioxide stream in the carbon dioxide purification and compression unit to produce a compressed carbon dioxide fluid.

In some examples, the method further includes recirculating a portion of the compressed carbon dioxide fluid as a working fluid for the oxy-fuel power generation system.

In some examples, the water separator includes a screw conveyor comprising a screw. In a particular embodiment, the step of condensing water out of the air stream comprises condensing water out of the air stream onto the screw as water ice, sending the dry air stream out of the screw conveyor via a gas exit, and rotating the screw such that the water ice is conveyed out of the screw conveyor via a solids exit.

In some examples, the carbon dioxide separator includes a screw conveyor comprising a screw. In a particular embodiment, the step of condensing carbon dioxide out of the dry air stream comprises condensing carbon dioxide out of the dry air stream onto the screw as dry ice, sending the CO2-barren air stream out of the screw conveyor via a gas exit, and rotating the screw such that the dry ice is conveyed out of the screw conveyor via a solids exit.

In some examples, the disclosure provides a method for separating components of an air stream including water, carbon dioxide, nitrogen, argon, and oxygen. The method includes passing the air stream into an air separation unit comprising a water separator, a carbon dioxide separator, and a cryogenic separator. The method further includes condensing water out of the air stream against a first cryogenic fluid stream in the water separator, forming a dry air stream and an H2O stream. The method further includes condensing carbon dioxide out of the dry air stream against a second cryogenic fluid stream in the carbon dioxide separator, forming a CO2-barren air stream and a concentrated carbon dioxide stream. The method further includes separating the CO2-barren air stream into a nitrogen product stream, an argon product stream, and an oxygen product stream in the cryogenic separator. The method further includes using one or more of the nitrogen product stream, the argon product stream, and the oxygen product stream as the first cryogenic fluid stream, the second cryogenic fluid stream, or both. In a particular embodiment, the nitrogen product stream, the argon product stream, and/or the oxygen product stream are used as the first cryogenic fluid stream, the second cryogenic fluid stream, or both, after a startup period.

In some examples, the method further includes combusting the oxygen product stream in a combustor of an oxy-fuel power generation system.

In some examples, the method further includes purifying and compressing the concentrated carbon dioxide stream in a carbon dioxide purification and compression unit.

In some examples, the method further includes combining a carbon dioxide discharge product of the combustor with the concentrated carbon dioxide stream in the carbon dioxide purification and compression unit to produce a compressed carbon dioxide fluid.

In some examples, the method further includes recirculating a portion of the compressed carbon dioxide fluid as a working fluid for the oxy-fuel power generation system.

In some examples, the water separator includes a first train and a second train. In a particular embodiment, the step of condensing water out of the air stream includes using the first train to condense water out of the air stream as a first water ice; using the second train to condense water out of the air stream as a second water ice; while using the second train to condense water, heating the first train to melt the first water ice to form a first liquid water; draining the first liquid water from the first train; while using the first train to condense water, heating the second train to melt the second water ice to form a second liquid water; and draining the second liquid water from the second train.

In some examples, the carbon dioxide separator includes a first train and a second train. In a particular embodiment, the step of condensing carbon dioxide out of the dry air stream includes condensing carbon dioxide out of the dry air stream as a first dry ice in the first train; condensing carbon dioxide out of the dry air stream as a second dry ice in the second train; while using the second train to condense carbon dioxide, heating the first train to melt or sublimate the first dry ice to form a first liquid carbon dioxide or a first gaseous carbon dioxide; draining the first liquid carbon dioxide or the first gaseous carbon dioxide from the first train; while using the first train to condense carbon dioxide, heating the second train to melt or sublimate the second dry ice to form a second liquid carbon dioxide or a second gaseous carbon dioxide; and draining the second liquid carbon dioxide or the second gaseous carbon dioxide from the second train.

In some examples, the method further includes adding flue gas from a combustion process to the air stream passing into the air separation unit. In some examples, the method further includes stripping NOx and SOx from the flue gas before adding the flue gas to the air stream. In some examples, the method further includes stripping NOx and SOx from the flue gas via an acid gas stripper, after the step of condensing water out of the air stream and before the step of condensing carbon dioxide out of the dry air stream.

In some examples, during startup of the air separation unit, the method further includes using a cryogenic coolant from a standalone cryogenic unit as the first cryogenic fluid stream, the second cryogenic fluid stream, or both.

In some examples, the method further includes using the H2O stream as cooling water in a power generation system.

In some examples, the method further includes compressing the air stream before the step of condensing water, such that the carbon dioxide condenses as a liquid during the step of condensing carbon dioxide.

In some examples, the method further includes compressing the dry air stream before the step of condensing carbon dioxide, such that the carbon dioxide condenses as a liquid during the step of condensing carbon dioxide.

In some examples, the method further includes compressing the CO2-barren air stream into the cryogenic separator.

In some examples, the method further includes heating the H2O stream with a hot fluid from another process, the concentrated carbon dioxide stream, or both.

In some examples, the water separator includes a screw conveyor comprising a screw. In a particular embodiment, the step of condensing water out of the air stream includes condensing water out of the air stream onto the screw as water ice, sending the dry air stream out of the screw conveyor via a gas exit, and rotating the screw such that the water ice is conveyed out of the screw conveyor via a solids exit.

In some examples, the carbon dioxide separator includes a screw conveyor comprising a screw. In a particular embodiment, the step of condensing carbon dioxide out of the dry air stream includes condensing carbon dioxide out of the dry air stream onto the screw as dry ice, sending the CO2-barren air stream out of the screw conveyor via a gas exit, and rotating the screw such that the dry ice is conveyed out of the screw conveyor via a solids exit.

In some examples, the disclosure provides a system for separating components of an air stream including water, carbon dioxide, nitrogen, argon, and oxygen in an oxy-fuel power generation system. The system includes an air separation unit to separate the air stream into components, the air separation unit including a water separator, a carbon dioxide separator, and a cryogenic separator. The system includes a combustor coupled to the cryogenic separator. The system includes a carbon dioxide purification and compression unit coupled to the carbon dioxide separator. The system includes the water separator to condense water out of the air stream by cooling via a first cryogenic fluid stream, forming a dry air stream and an H2O stream. The system includes the carbon dioxide separator to condense carbon dioxide out of the dry air stream by cooling via a second cryogenic fluid stream, forming a CO2-barren air stream and a concentrated carbon dioxide stream. The system also includes the cryogenic separator to separate the CO2-barren air stream into a nitrogen product stream, an argon product stream, and an oxygen product stream, and to use one or more of the nitrogen product stream, the argon product stream, and the oxygen product stream as the first cryogenic fluid stream, the second cryogenic fluid stream, or both. In a particular embodiment, the nitrogen product stream, the argon product stream, and/or the oxygen product stream are used as the first cryogenic fluid stream, the second cryogenic fluid stream, or both, after a startup period. The system also includes the combustor to combust the oxygen product stream. The system also includes the carbon dioxide purification and compression unit to purify and compress the concentrated carbon dioxide stream.

In some examples, the water separator includes a first train and a second train. In a particular embodiment, the system includes the first train to condense water out of the air stream as a first water ice; the second train to condense water out of the air stream as a second water ice; a first heater to heat the first train such that the first water ice melts to form a first liquid water, the first train being further configured to drain the first liquid water; a second heater to heat the second train such that the second water ice melts to form a second liquid water, the second train being further configured to drain the second liquid water; and a controller to direct the air stream to the first train while the second heater heats the second train and to direct the air stream to the second train while the first heater heats the first train.

In some examples, the carbon dioxide separator includes a first train and a second train. In a particular embodiment, the system includes the first train to condense carbon dioxide out of the dry air stream as a first dry ice; the second train to condense carbon dioxide out of the dry air stream as a second dry ice; a first heater to heat the first train such that the first dry ice melts or sublimates to form a first liquid carbon dioxide or a first gaseous carbon dioxide, the first train being further configured to drain the first liquid carbon dioxide or the first gaseous carbon dioxide; a second heater to heat the second train such that the second dry ice melts or sublimates to form a second liquid carbon dioxide or a second gaseous carbon dioxide, the second train being further configured to drain the second liquid carbon dioxide or the second gaseous carbon dioxide; and a controller to direct the dry air stream to the first train while the second heater heats the second train and to direct the dry air stream to the second train while the first heater heats the first train.

In some examples, the system further includes a combustion unit to produce flue gas and send the flue gas to join the air stream passing into the air separation unit. In some examples, the system further includes a stripper to strip NOx and SOx from the flue gas before adding the flue gas to the air stream. In some examples, the system further includes a stripper to strip NOx and SOx from the flue gas, the stripper being located between the water separator and the carbon dioxide separator.

In some examples, the system further includes a standalone cryogenic unit to provide a cryogenic coolant as the cryogenic coolant stream during startup of the air separation unit.

In some examples, the system further includes a power generation system to receive the H2O stream as a cooling water.

In some examples, the system further includes a compressor to compress the air stream before the air stream enters the water separator, such that the carbon dioxide condenses as a liquid in the3 carbon dioxide separator.

In some examples, the system further includes a compressor to compress the dry air stream before the dry air stream enters the carbon dioxide separator such that the carbon dioxide condenses as a liquid in the carbon dioxide separator.

In some examples, the system further includes a compressor to compress the CO2-barren air stream into the cryogenic separator.

In some examples, the system further includes another process to pass a hot fluid to heat the H2O stream, the concentrated carbon dioxide stream, or both. In a particular embodiment, it is the oxy-fuel power generation system that is configured to pass the hot fluid to heat the H2O stream, the concentrated carbon dioxide stream, or both.

In some examples, the system further includes the combustor to produce a carbon dioxide discharge product. In a particular embodiment, the carbon dioxide purification and compression unit is further configured to receive the carbon dioxide discharge product and to combine the carbon dioxide discharge product with the concentrated carbon dioxide stream to produce a compressed carbon dioxide fluid.

In some examples, the system further includes the oxy-fuel power generation system to recirculate a portion of the compressed carbon dioxide fluid as a working fluid.

In some examples, the water separator includes a screw conveyor comprising a screw, a gas exit, and a solids exit. The screw is cooled to condense water out of the air stream onto the screw as water ice. The gas exit sends the concentrated carbon dioxide stream out of the screw conveyor. The screw rotates to send the water ice out of the screw conveyor via the solids exit.

In some examples, the carbon dioxide separator includes a screw conveyor comprising a screw, a gas exit, and a solids exit. The screw is cooled to condense carbon dioxide out of the dry air stream onto the screw as dry ice. The gas exit sends the CO2-barren air stream out of the screw conveyor. The screw rotates to send the dry ice out of the screw conveyor via a solids exit.

In some examples, the disclosure provides a system for separating components of an air stream comprising water, carbon dioxide, nitrogen, argon, and oxygen. The system includes an air separation unit to separate the air stream into components, the air separation unit including a water separator, a carbon dioxide separator, and a cryogenic separator. The system includes the water separator to condense water out of the air stream by cooling via a first cryogenic fluid stream, forming a dry air stream and an H2O stream. The system includes the carbon dioxide separator to condense carbon dioxide out of the dry air stream by cooling via a second cryogenic fluid stream, forming a CO2-barren air stream and a concentrated carbon dioxide stream. The system includes the cryogenic separator to separate the CO2-barren air stream into a nitrogen product stream, an argon product stream, and an oxygen product stream, and to use one or more of the nitrogen product stream, the argon product stream, and the oxygen product stream as the first cryogenic fluid stream, the second cryogenic fluid stream, or both. In a particular embodiment, the nitrogen product stream, the argon product stream, and/or the oxygen product stream are used as the first cryogenic fluid stream, the second cryogenic fluid stream, or both, after a startup period.

In some examples, the system further includes a combustor coupled to the cryogenic separator to combust the oxygen product stream. In a particular embodiment, the combustor is part of the oxy-fuel power generation system.

In some examples, the system further includes a carbon dioxide purification and compression unit coupled to the carbon dioxide separator to purify and compress the concentrated carbon dioxide stream.

In some examples, the system further includes the combustor to produce a carbon dioxide discharge product. In a particular embodiment, the carbon dioxide purification and compression unit receives the carbon dioxide discharge product and combines the carbon dioxide discharge product with the concentrated carbon dioxide stream to produce a compressed carbon dioxide fluid.

In some examples, the system further includes the oxy-fuel power generation system to recirculate a portion of the compressed carbon dioxide fluid as a working fluid.

In some examples, the water separator includes a first train and a second train, the first train to condense water out of the air stream as a first water ice; the second train to condense water out of the air stream as a second water ice. In a particular embodiment, the system further comprises a first heater to heat the first train while the air stream passes through the second train such that the first water ice melts to form a first liquid water, the first train being further configured to drain the first liquid water; and a second heater to heat the second train while the air stream passes through the first train, such that the second water ice melts to form a second liquid water, the second train being further configured to drain the first liquid water.

In some examples, the carbon dioxide separator includes a first train and a second train, the first train to condense carbon dioxide out of the dry air stream as a first dry ice; the second train to condense carbon dioxide out of the dry air stream as a second dry ice. In a particular embodiment, the system further comprises a first heater to heat the first train while the dry air stream passes through the second train such that the first dry ice melts or sublimates to form a first liquid carbon dioxide or a first gaseous carbon dioxide, the first train being further configured to drain the first liquid carbon dioxide or the first gaseous carbon dioxide; and a second heater to heat the second train while the dry air stream passes through the first train such that the second dry ice melts to form a second liquid carbon dioxide or a second gaseous carbon dioxide, the second train being further configured to drain the second liquid carbon dioxide or the second gaseous carbon dioxide.

In some examples, the system further includes a combustion unit to produce flue gas and send the flue gas to join the air stream passing into the air separation unit. In some examples, the system further includes a stripper to strip NOx and SOx from the flue gas before adding the flue gas to the air stream. In some examples, the system further includes a stripper to strip NOx and SOx from the flue gas, the stripper being located between the water separator and the carbon dioxide separator.

In some examples, the system further includes a standalone cryogenic unit to provide a cryogenic coolant as the cryogenic coolant stream during startup of the air separation unit.

In some examples, the system further includes a power generation system to receive the H2O stream as a cooling water.

In some examples, the system further includes a compressor to compress the air stream before the air stream enters the water separator, such that the carbon dioxide condenses as a liquid in the carbon dioxide separator.

In some examples, the system further includes a compressor to compress the dry air stream before the dry air stream enters the carbon dioxide separator, such that the carbon dioxide condenses as a liquid in the carbon dioxide separator.

In some examples, the system further includes a compressor to compress the CO2-barren air stream into the cryogenic separator.

In some examples, the system further includes another process to pass a hot fluid to heat the H2O stream, the concentrated carbon dioxide stream, or both. In a particular embodiment, it is the oxy-fuel power generation system that is configured to pass the hot fluid to heat the H2O stream, the concentrated carbon dioxide stream, or both.

In some examples, the water separator includes a screw conveyor comprising a screw, a gas exit, and a solids exit. The screw is cooled to condense water out of the air stream onto the screw as water ice. The gas exit sends the concentrated carbon dioxide stream out of the screw conveyor. The screw rotates to send the water ice out of the screw conveyor via the solids exit.

In some examples, the carbon dioxide separator includes a screw conveyor comprising a screw, a gas exit, and a solids exit. The screw is cooled to condense carbon dioxide out of the dry air stream onto the screw as dry ice. The gas exit sends the CO2-barren air stream out of the screw conveyor. The screw rotates to send the dry ice out of the screw conveyor via a solids exit.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process flow diagram showing an example system for processing gases.

FIG. 2 is a process flow diagram showing an example system for processing gases.

FIG. 3 is a block diagram showing an example method for processing gases.

FIG. 4 is a block diagram showing an example method for processing gases.

FIG. 5 is a process flow diagram showing an example system for processing gases.

### DETAILED DESCRIPTION

The following description recites various aspects and embodiments of the subject matter disclosed herein. No particular embodiment is intended to define the scope of the present subject matter. Rather, the embodiments provide non-limiting examples of various systems and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the word “to” with respect to an element encompasses “configured to” and “adapted to.”

As used herein, “about” means within ±10% of the stated value, e.g., within ±5% of the stated value, or within ±2% of the stated value.

As used herein, “condense” and “condensation” are defined to include both gas-to-liquid condensation and gas-to-solid deposition or desublimation. In other words, condensation is the act of turning a gas phase to a condensed phase, wherein condensed phases are liquid or solid.

As used herein, a “CO2-barren” fluid stream means a fluid stream from which a majority of the carbon dioxide has been removed. That is, a CO2-barren fluid stream is a fluid stream from which more than about 50% of the carbon dioxide in the original fluid stream, from which the CO2-barren fluid stream is derived, has been removed. In some examples, a CO2-barren fluid stream is a fluid stream from which more than about 90% of the carbon dioxide in the original fluid stream has been removed, e.g., about 95% or more, or about 98% or more, or about 99% or more, or about 99.9%. A CO2-barren fluid stream may include, for example, about 0.1% to about 49% of the carbon dioxide in the original fluid stream from which the CO2-barren fluid stream is derived, e.g., about 0.1% to about 20%, or about 0.1% to about 10%, or about 0.1% to about 5%. In some examples, a CO2-barren fluid stream may be derived from a stream of ambient air. The stream of ambient air may, in some examples, be processed before removing CO2 therefrom, e.g., may have liquid water condensed therefrom, to form a dry air stream from which CO2 is removed to form the CO2-barren fluid stream.

As used herein, a “dry” fluid stream means a fluid stream from which a majority of the water has been removed. That is, a dry fluid stream is a fluid stream from which more than about 50% of the water in the original fluid stream, from which the dry fluid stream is derived, has been removed. In some examples, a dry fluid stream is a fluid stream from which more than about 90% of the water in the original fluid stream has been removed, e.g., about 95% or more, or about 98% or more, or about 99% or more, or about 99.9%. A dry fluid stream may include, for example, about 0.1% to about 49% of the water in the original fluid stream from which the dry fluid stream is derived, e.g., about 0.1% to about 20%, or about 0.1% to about 10%, or about 0.1% to about 5%. In some examples, a dry fluid stream may be derived from a stream of ambient air. The stream of ambient air may, in some examples, be processed before removing water therefrom, e.g., may have dust and particulates removed therefrom, to form a filtered air stream from which water is removed to form the dry air stream.

As used herein, a “hot” fluid stream is a heat exchange fluid stream that is at a higher temperature than the stream it is flowing against in the heat exchanger. For example, if a product fluid stream is at OC, the hot fluid stream is above that temperature and is used to warm the product fluid stream.

Carbon dioxide and water removal from air streams before cryogenic air separation is energy intensive, and typical technologies, such as adsorption, are often cost prohibitive. The present disclosure describes an integrated approach to air separation that allows for integration of the cryogenic air separation units with the water and carbon dioxide removal steps. This allows for capture of carbon dioxide from a feed that typically is not captured due to low concentration. In one example, the air separation unit is integrated with an oxy-fuel combustion process where carbon dioxide is used as a diluent with oxygen for combustion of natural gas or other hydrocarbon fuels. Oxy-fuel combustion requires purified oxygen, typically produced by cryogenic air separation. Rather than waste the cryogenic fluid streams, embodiments of the technology disclosed herein provide that the liquid nitrogen, liquid argon, cold oxygen, or a combination of them, can be used to condense (as liquids or solids) the water and carbon dioxide out of the feed air stream. The oxygen can then be sent to the oxy-fuel combustor, and the carbon dioxide can be sent to a carbon dioxide purification and compression unit for utilization or sequestration. The combustion product of the combustor, a carbon dioxide working fluid, drives the turbine of the oxy-fuel power generation system. This product is then processed and sent to the carbon dioxide purification and compression unit, combined with other carbon dioxide streams, and recirculated into the combustor as diluent or discharged as a product. This integrated approach makes the economics feasible for extracting carbon dioxide from ambient air as a product.

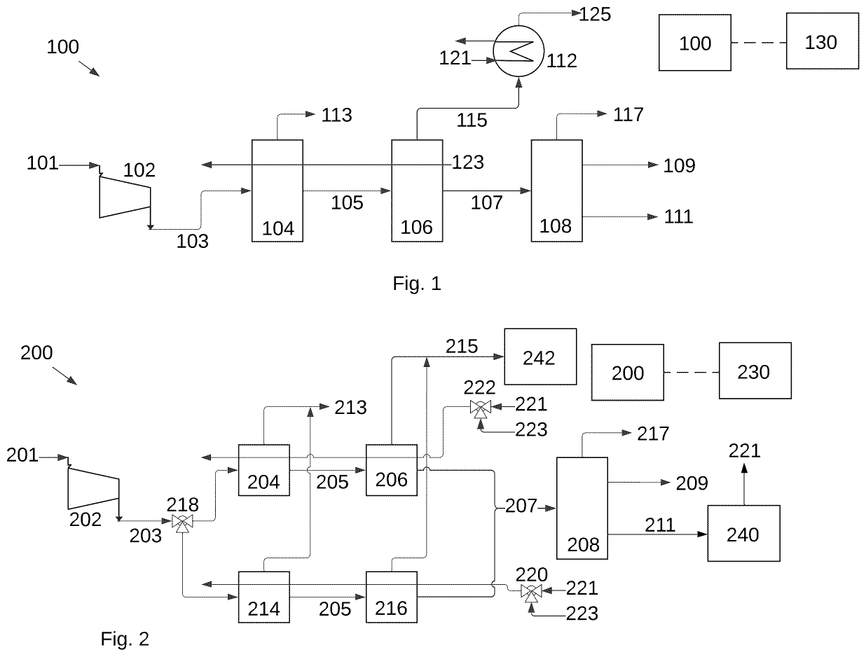

Now referring to FIG. 1, FIG. 1 is a process flow diagram showing an example system 100 for processing gases that may be used in some examples provided herein. This example is purely illustrative, and multiple other examples are envisioned or may be readily envisioned without undue experimentation.

In some examples, system 100 is an air separation unit for separating components of an air stream from one another. In the nonlimiting configuration illustrated in FIG. 1, system 100 includes compressor 102, water separator 104, carbon dioxide separator 106, cryogenic separation unit 108, heat exchanger 112, and controller 130. Compressor 102 receives air (e.g., ambient air) 101 via suitable piping (piping not specifically labeled in FIG. 1) and forces the ambient air via suitable piping into water separator 104 as feed air 103. Air 101 contains standard air components, including nitrogen, oxygen, carbon dioxide, argon, and water.

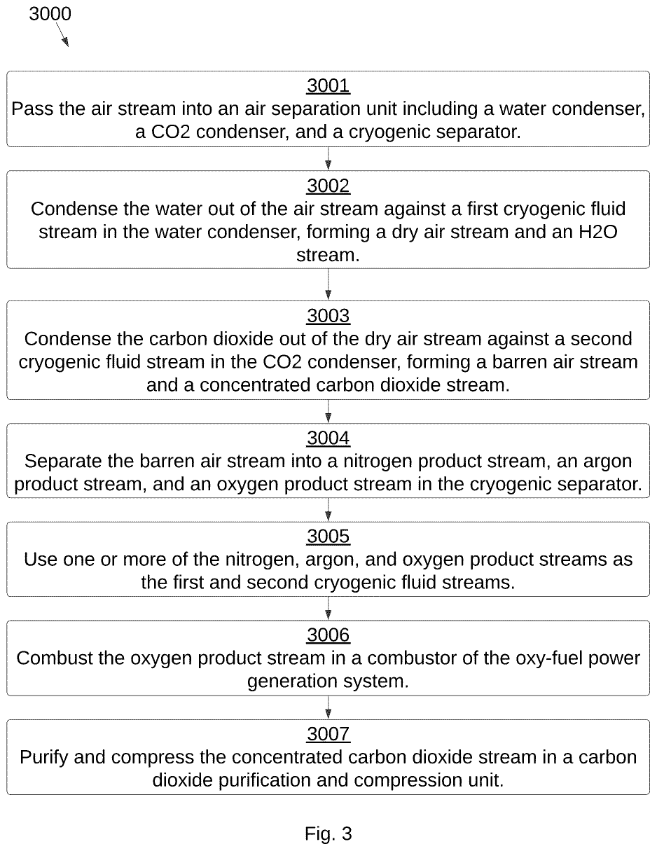

Water separator 104 is cooled by indirect contact with a cryogenic stream 123 (which may be produced using system 100 in a manner such as described herein), such that the water separator 104 cools the feed air 103 sufficiently to condense the water from feed air 103, forming liquid water stream 113 and dry air stream 105. Piping passes dry air stream 105 into carbon dioxide separator 106, which cools the dry air stream using indirect contact with the cryogenic stream 123 to produce liquid carbon dioxide stream 115 and a CO2-barren air stream 107. Heat exchanger 112 receives the liquid carbon dioxide stream 115 from carbon dioxide separator 106 via piping, and warms the liquid carbon dioxide stream against a hot fluid stream 121 from another process, such as a hot fluid from an oxy-fuel combustion process, generating a carbon dioxide fluid stream 125. Piping may send carbon dioxide fluid stream 125 to a carbon compression and purification unit (242 in FIG. 2). The compressed, purified carbon dioxide then may be suitably sequestered, stored, or used in a process.

Piping passes CO2-barren air stream 107 from carbon dioxide separator 106 through cryogenic separation unit 108 which separates the CO2-barren air stream into liquid nitrogen product stream 117, oxygen product stream 109, and liquid argon product stream 111. In some examples, piping optionally may send oxygen product stream 111 as a feed to an oxy-fuel combustion process (240 in FIG. 2).

Controller 130 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 130 and the system 100 may be implemented using any suitable combination of hardware and software.

In some examples, cryogenic stream 123, used to cool carbon dioxide separator 106 and water separator 104, may be sourced from one or more of the liquid nitrogen product stream 117, the liquid argon product stream 109, or oxygen product stream 111. Utilization of the cryogenically chilled streams as the cooling fluid in the beginning of the process increases the efficiency of the system, decreasing the parasitic load of water and carbon dioxide removal on the process. Further, when the oxygen is used in combustion, the oxygen is utilized at high temperatures, such that the cold would be otherwise wasted.

It will be appreciated that compressor 102 need not necessarily be included in system 100. In examples in which compressor 102 is included, the compressor need not necessarily be located upstream of water separator 104. Illustratively, in some examples, compressor 102 is located between water separator 104 and carbon dioxide separator 106.

Now referring to FIG. 2, FIG. 2 is a process flow diagram showing an example system 200 for processing gases that may be used in some examples provided herein. This example is purely illustrative, and multiple other examples are envisioned or may be readily envisioned without undue experimentation. FIG. 2 is similar to FIG. 1, but condensation occurs as solids in the water and the carbon dioxide systems, not as a liquid. This necessitates the semi-batch approach used in FIG. 2 and controlled by controller 230. Cycling between condensing solids and then melting/sublimating and removing the products allows for the process to still be continuous, but without operating at the difficult pressures to allow for liquid condensation of carbon dioxide.

In some examples, system 200 is an air separation unit for separating components of an air stream from one another. In the nonlimiting configuration illustrated in FIG. 2, system 200 includes blower 202, first train water separator 204, first train carbon dioxide separator 206, second train water separator 214, second train carbon dioxide separator 216, cryogenic separation unit 208, valves 218, 220, and 222, and controller 230. Blower 202 receives air (e.g., ambient air) 201 via suitable piping (piping not specifically labeled in FIG. 2) and forces the ambient air via suitable piping into 3-way valve 218 as feed air 203. Air 201 contains standard air components, including nitrogen, oxygen, carbon dioxide, argon, and water.

Air is split between trains by 3-way valve 218. The first train consists of water separator 204 and carbon dioxide separator 206. The second train consists of water separator 214 and carbon dioxide separator 216. One train condenses solid water and solid carbon dioxide while heating the other train to remove the solids. While the second train is in recovery, valve 218 sends the feed air 203 into water separator 204. While the first train is in recovery, valve 218 sends the feed air 203 into water separator 214. Cryogenic fluid stream 223 (which may be produced using system 200 in a manner such as described herein) cools the feed air 203 to condense water out as a solid water ice and produce a dry air stream 205. Piping passes dry air stream 205 into carbon dioxide separator 206 while train one is operating and into condenser 216 while train two is operating, which cools the dry air stream 205 using indirect contact with the cryogenic fluid stream 223, condensing carbon dioxide out as dry ice and producing a CO2-barren air stream 207. In some examples, each of the units 204/214 and 206/216 receive a separate cryogenic fluid stream 223, rather than one that passes through both. In this example, the stream 223 passing through both in reverse is of benefit as the carbon dioxide condensation requires a lower temperature than water condensation.

Piping passes CO2-barren air stream 207 from the carbon dioxide separators 206 and 216 through cryogenic separation unit 208, which separates the CO2-barren air stream 207 into liquid nitrogen product stream 217, liquid argon product stream 209, and oxygen product stream 211. In some examples, piping optionally may send oxygen product stream 211 as a feed to an oxy-fuel combustion process 240.

In some examples, cryogenic stream 223, used to cool carbon dioxide separators 206 and 216 and water separators 204 and 214, may be sourced from one or more of the liquid nitrogen product stream 217, the liquid argon product stream 209, or oxygen product stream 211. Utilization of the cryogenically chilled streams as the cooling fluid in the beginning of the process increases the efficiency of the system, decreasing the parasitic load of water and carbon dioxide removal on the process. Further, when the oxygen is used in combustion, the oxygen is utilized at high temperatures, such that the cold would be otherwise wasted.

In some examples, a 3-way valve 222 alternates between passing a hot fluid stream 221 and the cryogenic fluid stream 223. The hot fluid stream may be from an external source, such as an oxy-fuel combustion process.

Solids build up in both condensers 204 and 206, necessitating switching the feed air 203 from the first train to the second train. In this example, valves 220 and 222 switch such that cryogenic fluid stream 223 passes into the second train and the hot fluid stream 221 passes into the first train. While hot fluid stream 221 is passed through the condensers 204 and 206, solid water ice melts and leaves as water stream 213 while dry ice sublimates and leaves as carbon dioxide stream 215. In some examples, carbon dioxide stream 215 may be sent to a carbon compression and purification unit 242.

Controller 230 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 230 and the system 200 may be implemented using any suitable combination of hardware and software.

In the examples of FIG. 2, valves 220 and 222 are shown to select between hot and cold streams. This should not be considered to limit the means of passing hot and cold through the unit operations shown. In some examples, the hot and cold streams may be passed through the systems via totally independent piping systems. Further, instead of valve 218, separator blowers 202 could be provided for each train. The exact layout of equipment is based on standard equipment selection and design and the figures are not intended to limit standard variation.

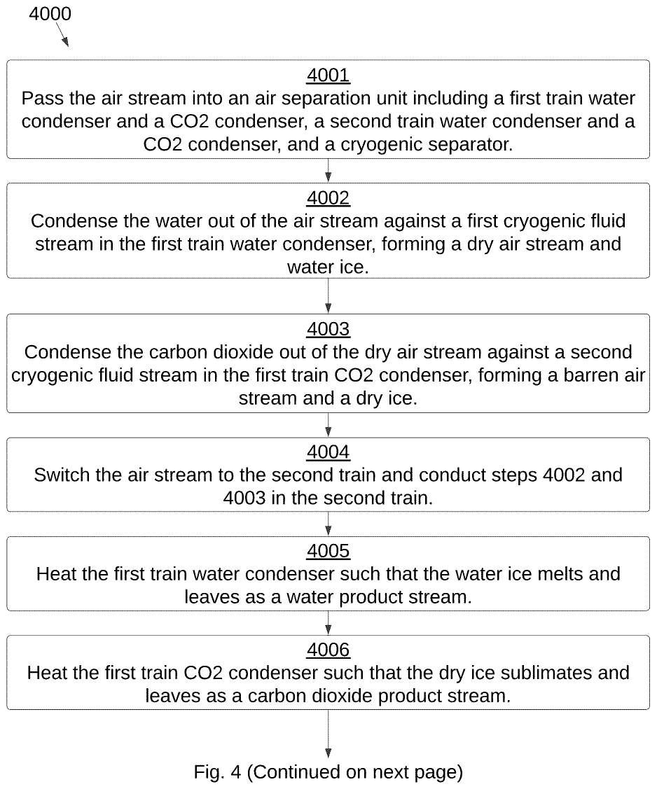

Illustratively, FIG. 3 is a block diagram showing an example method 3000 for processing gases that may be used in some examples provided herein. The method separates components of an air stream including water, carbon dioxide, nitrogen, argon, and oxygen. In some examples, the separation is part of an oxy-fuel power generation system. While method 3000 optionally may be implemented using system 100, it will be appreciated that any other suitable combination of components may be used to implement method 3000.

Method 3000 illustrated in FIG. 3 may include passing the air stream into an air separation unit that includes a water separator, a carbon dioxide separator, and a cryogenic separator (operation 3001). For example, in a manner such as described above with reference to FIG. 1, air separation unit 100 may include water separator 104, carbon dioxide separator 106, and a cryogenic separation unit 108. Air (e.g., ambient air) 101 may be passed directly into the air separation unit via suitable piping, or the air may be compressed using compressor 102 and passed to water separator 104 via suitable piping.

Referring again to FIG. 3, method 3000 may also include condensing the water out of the air stream against a first cryogenic fluid stream in the water separator, forming a dry air stream and an H2O stream (operation 3002). For example, in a manner such as described above with reference to FIG. 1, water separator 104 may condense water out of feed air 103 by cooling with cryogenic air stream 113 to form dry air stream 105 and liquid water stream 113.

Method 3000 may also include condensing the carbon dioxide out of the dry air stream against a second cryogenic fluid stream in the carbon dioxide separator, forming a CO2-barren air stream and a concentrated carbon dioxide stream (operation 3003). For example, in a manner such as described above with reference to FIG. 1, carbon dioxide separator 106 may condense carbon dioxide out of dry air stream 205 by cooling with cryogenic air stream 113 to form liquid carbon dioxide stream 115 and barren air stream 107.

Method 3000 may also include separating the CO2-barren air stream into a nitrogen product stream, an argon product stream, and an oxygen product stream in the cryogenic separator (operation 3004). For example, in a manner such as described above with reference to FIG. 1, the cryogenic separation unit 108 may separate barren air stream 107 into liquid nitrogen product stream 117, liquid argon product stream 109, and oxygen product stream 111.

Method 3000 may also include using one or more of the nitrogen, argon, and oxygen product streams as the first or second cryogenic fluid streams (operation 3005). For example, in a manner such as described above with reference to FIG. 1, the cryogenic fluid stream 123 may be sourced from liquid nitrogen product stream 117, liquid argon product stream 109, or oxygen product stream 111.

Method 3000 may also include combusting the oxygen product stream in a combustor of the oxy-fuel power generation system (operation 3006). For example, in a manner such as described above with reference to FIG. 1, oxygen product stream 111 may be passed to the oxy-fuel power generation system's combustor (240 in FIG. 2).

Method 3000 may also include purifying and compressing the concentrated carbon dioxide stream in a carbon dioxide purification and compression unit (operation 3007). For example, in a manner such as described above with reference to FIG. 1, liquid carbon dioxide product stream 115 may be heated in an indirect contact heat exchanger, such as exchanger 112, and sent to the carbon dioxide purification and compression unit (242 in FIG. 2) for compression and purification.

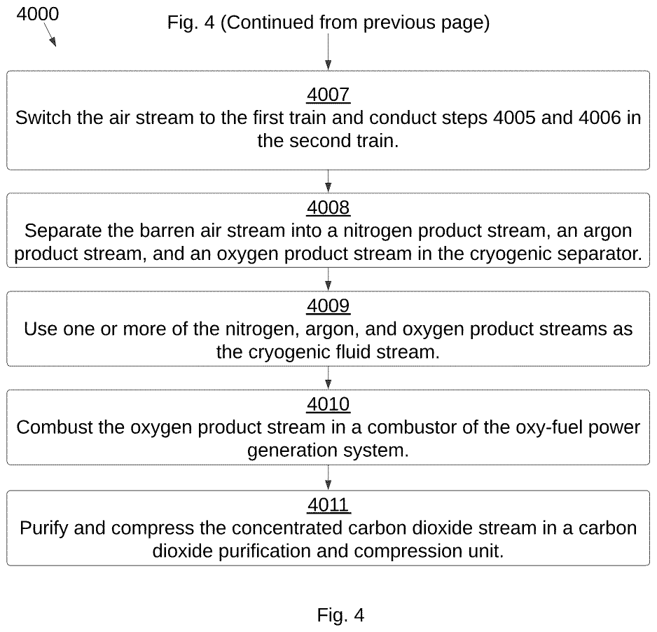

Illustratively, FIG. 4 is a block diagram showing an example method 4000 for processing gases that may be used in some examples provided herein. The method separates components of an air stream including water, carbon dioxide, nitrogen, argon, and oxygen.

FIG. 4 is similar to FIG. 3, but condensation occurs as solids in the water and the carbon dioxide systems, not as a liquid. This necessitates the semi-batch approach used in FIG. 4. Cycling between condensing solids and then melting/sublimating and removing the products allows for the process to still be continuous, but without operating at the difficult pressures to allow for liquid condensation of carbon dioxide.

While method 4000 optionally may be implemented using system 200, it will be appreciated that any other suitable combination of components may be used to implement method 4000.

Method 4000, illustrated in FIG. 4, may include passing the air stream into an air separation unit that includes a first train water separator and carbon dioxide separator, a second train water separator and carbon dioxide separator, and a cryogenic separator (operation 4001). For example, in a manner such as described above with reference to FIG. 2, air separation unit 200 may include first train water separator 204, first train carbon dioxide separator 206, second train water separator 214, second train carbon dioxide separator 216, and a cryogenic separation unit 208. Air (e.g., ambient air) 201 may be passed using blower 202 to alternating trains via suitable piping.

Returning again to FIG. 4, method 4000 may also include condensing the water out of the air stream against a first cryogenic fluid stream in the first train water separator, forming a dry air stream and a first water ice (operation 4002). For example, in a manner such as described above with reference to FIG. 2, first train water separator 204 may condense water out of feed air 203 by cooling against cryogenic fluid stream 223 to form dry air stream 205 and first water ice that remains in the condenser 204.

Method 4000 may also include condensing the carbon dioxide out of the dry air stream against a second cryogenic fluid stream in the first train carbon dioxide separator, forming a CO2-barren air stream and a first dry ice (operation 4003). For example, in a manner such as described above with reference to FIG. 2, first train carbon dioxide separator 206 may condense carbon dioxide out of dry air stream 205 by cooling against cryogenic fluid stream 223 to form barren air stream 107 and first dry ice that remains in the condenser 206.

Method 4000 may also include switching the air stream to the second train and conducting operations 4002 and 4003 in the second train (operation 4004). For example, in a manner such as described above with reference to FIG. 2, second train water separator 214 may condense water out of feed air 203 to form dry air stream 205 and second water ice that remains in the condenser 214. Second train carbon dioxide separator 216 may condense carbon dioxide out of dry air stream 205 to form barren air stream 207 and second dry ice that remains in the condenser 216.

Method 4000 may also include heating the first train water separator such that the first water ice melts and leaves as a water product stream (operation 4005). For example, in a manner such as described above with reference to FIG. 2, hot fluid stream 221 may be directed by 3-way valve 222 through first train water separator 204, the hot fluid stream 221 heating the first train water separator 204 to melt the first water ice and remove the water as water product stream 213.

Method 4000 may also include heating the first train carbon dioxide separator such that the first dry ice sublimates and leaves as a carbon dioxide product stream (operation 4006). For example, in a manner such as described above with reference to FIG. 2, hot fluid stream 221 may be directed by 3-way valve 222 through first train carbon dioxide separator 206, the hot fluid stream 221 heating the first train carbon dioxide separator 206 to sublimate the first dry ice and remove the carbon dioxide as carbon dioxide product stream 215.

Method 4000 may also include switching the air stream to the first train and conducting operations 4005 and 4006 in the second train (operation 4007). For example, in a manner such as described above with reference to FIG. 2, hot fluid stream 221 may be directed by 3-way valve 220 through second train carbon dioxide separator 216 and through second train water separator 214, the hot fluid stream 221 heating the second train carbon dioxide separator 216 to sublimate the second dry ice and remove the carbon dioxide as carbon dioxide product stream 215, and heating the second train water separator 214 to melt the second water ice and remove the water as water product stream 213.

Method 4000 may also include separating the CO2-barren air stream into a nitrogen product stream, an argon product stream, and an oxygen product stream in the cryogenic separator (operation 4008). For example, in a manner such as described above with reference to FIG. 2, the cryogenic separation unit 208 may separate the barren air stream 207 into liquid nitrogen product stream 217, liquid argon product stream 209, and oxygen product stream 211.

Method 4000 may also include using one or more of the nitrogen, argon, and oxygen product streams as the first and second cryogenic fluid streams (operation 4009). For example, in a manner such as described above with reference to FIG. 2, the cryogenic fluid stream 223 may be sourced from liquid nitrogen product stream 217, liquid argon product stream 209, or oxygen product stream 211.

Method 4000 may also include combusting the oxygen product stream in a combustor of the oxy-fuel power generation system (operation 4010). For example, in a manner such as described above with reference to FIG. 2, oxygen product stream 211 may be passed to the oxy-fuel power generation system's combustor 240.

Method 4000 may also include purifying and compressing the concentrated carbon dioxide stream in a carbon dioxide purification and compression unit (operation 4011). For example, in a manner such as described above with reference to FIG. 2, liquid carbon dioxide product stream 215 may be sent to the carbon dioxide purification and compression unit 242 for compression and purification.

In some examples, the methods of FIG. 3 or FIG. 4 further include adding flue gas from a combustion process to the air stream passing into the air separation unit.

In some examples, the methods of FIG. 3 or FIG. 4 further include stripping NOx and SOx from the flue gas before adding the flue gas to the air stream.

In some examples, the methods of FIG. 3 or FIG. 4 further include stripping NOx and SOx from the flue gas between the water separator and the carbon dioxide separator via an acid gas stripper.

In some examples, during startup of the air separation units of FIG. 3 and FIG. 4, the method further includes replacing the cryogenic fluid streams by a cryogenic coolant from a standalone cryogenic unit.

In some examples, the methods of FIG. 3 or FIG. 4 further include using the H2O stream as cooling water in a power generation system.

In some examples, the methods of FIG. 3 or FIG. 4 further include compressing the air stream before the water separator such that the carbon dioxide condenses as a liquid.

In some examples, the methods of FIG. 3 or FIG. 4 further include compressing the dry air stream before the carbon dioxide separator such that the carbon dioxide condenses as a liquid. Condensation as a liquid is accomplished by compressing sufficiently to bring the temperature and pressure into liquid phase conditions.

In some examples, the methods of FIG. 3 or FIG. 4 further include compressing the CO2-barren air stream into the cryogenic separator. This compression with the subsequent cooling in the cryogenic separator liquefies the produced gas streams.

In some examples, the methods of FIG. 3 or FIG. 4 further include heating the H2O stream with a hot fluid from another process, the concentrated carbon dioxide stream, or both.

In some examples, the methods of FIG. 3 or FIG. 4 further include combining a carbon dioxide discharge product of the combustor with the concentrated carbon dioxide stream in the carbon dioxide purification and compression unit to produce a compressed carbon dioxide fluid.

In some examples, the methods of FIG. 3 or FIG. 4 further include recirculating a portion of the compressed carbon dioxide fluid as a working fluid for the oxy-fuel power generation system.

In some examples, the systems of FIG. 1 and FIG. 2 further include a combustion unit to produce flue gas and send the flue gas to join the air stream passing into the air separation unit.

In some examples, the systems of FIG. 1 and FIG. 2 further include a stripper to strip NOx and SOx from the flue gas before adding the flue gas to the air stream.

In some examples, the systems of FIG. 1 and FIG. 2 further include a stripper to strip NOx and SOx from the flue gas between the water separator and the carbon dioxide separator.

In some examples, the systems of FIG. 1 and FIG. 2 further include a standalone cryogenic unit to provide a cryogenic coolant to replace the cryogenic coolant stream during startup of the air separation unit.

In some examples, the systems of FIG. 1 and FIG. 2 further include a power generation system to receive the water stream as a cooling water.

In some examples, the systems of FIG. 1 and FIG. 2 further include a compressor to compress the air stream before the water separator such that the carbon dioxide condenses as a liquid.

In some examples, the systems of FIG. 1 and FIG. 2 further include a compressor to compress the dry air stream before the carbon dioxide separator such that the carbon dioxide condenses as a liquid. Condensation as a liquid is accomplished by compressing sufficiently to bring the temperature and pressure into liquid phase conditions.

In some examples, the systems of FIG. 1 and FIG. 2 further include a compressor to compress the CO2-barren air stream into the cryogenic separator. This compression with the subsequent cooling in the cryogenic separator liquefies the produced gas streams.

In some examples, the systems of FIG. 1 and FIG. 2 further include another process to pass a hot fluid to heat the H2O stream, the concentrated carbon dioxide stream, or both.

In some examples, the combustors of FIG. 1 and FIG. 2 produce a carbon dioxide discharge product, and the carbon dioxide purification and compression unit are to receive the carbon dioxide discharge product and the concentrated carbon dioxide stream and to produce a compressed carbon dioxide fluid.

In some examples, the systems of FIG. 1 and FIG. 2 further include the oxy-fuel power generation system to recirculate a portion of the compressed carbon dioxide fluid as a working fluid.

In the above examples, an oxy-fuel combustion system was provided as an example of sources for heat and destinations for product. However, other heat sources and product destinations are anticipated by the present disclosure. Any air separation unit utilizing cryogenics would be part of the present disclosure.

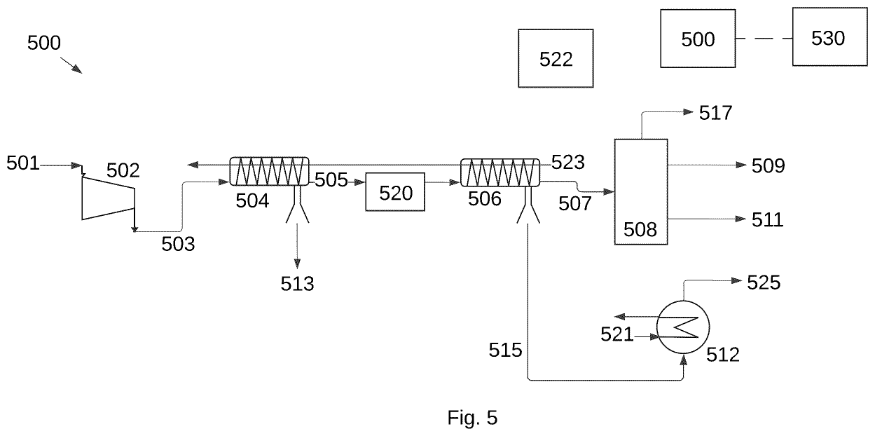

Now referring to FIG. 5, FIG. 5 is a process flow diagram showing an examples system 500 for processing gases that may be used in some examples provided herein. This example is purely illustrative, and multiple other examples are envisioned or may be readily envisioned without undue experimentation. This is a continuous operation version that condenses solids and discharges them as solids.

In some examples, system 500 is an air separation unit for separating components of an air stream from one another. In the nonlimiting configuration illustrated in FIG. 5, system 500 includes blower 502, water separator screw conveyor 504, carbon dioxide separator screw conveyor 506, cryogenic separation unit 508, heat exchanger 512, and controller 530. Blower 502 receives air (e.g., ambient air) 501 via suitable piping (piping not specifically labeled in FIG. 5) and forces the ambient air via suitable piping into water separator screw conveyor 504 as feed air 503. Air 501 contains standard air components, including nitrogen, oxygen, carbon dioxide, argon, and water.

The water separator screw conveyor 504 includes a screw, a gas exit, and a solids exit. The screw is cooled by cryogenic fluid stream 523 (which may be produced using system 500 in a manner such as described herein). Cooling the screw then cools the feed air 503 and condenses water onto the screw as a solid water ice and produces a dry air stream 505. The screw conveyor 504 passes the dry air stream 505 out of the screw conveyor 504 via the gas exit and piping passes the dry air stream 505 through a NOx/SOx stripper 520 and on to carbon dioxide separator 506. The screw rotates, advancing the solids out of the screw conveyor 504 through the solids exit and out as water ice product 513.

The NOx/SOx stripper 520 removes oxides of nitrogen and sulfur (NOx and SOx) from stream 505, leaving carbon dioxide in stream 505.

The carbon dioxide separator screw conveyor 506 includes a screw, a gas exit, and a solids exit. The screw is cooled by cryogenic fluid stream 523. Cooling the screw then cools the dry air stream 505 and condenses carbon dioxide onto the screw as a dry ice and produces a CO2-barren air stream 507. The screw conveyor 506 passes the CO2-barren stream 507 out of the screw conveyor 506 via the gas exit and piping passes the CO2-barren air stream 507 into the cryogenic separator 508. The screw rotates, advancing the solids out of the screw conveyor 506 through the solids exit and out as dry ice product 515.

Piping passes CO2-barren air stream 507 from the carbon dioxide separator 506 through cryogenic separation unit 508, which separates the CO2-barren air stream 507 into liquid nitrogen product stream 517, liquid argon product stream 509, and oxygen product stream 511. In some examples, piping optionally may send oxygen product stream 511 as a feed to an oxy-fuel combustion process (240 in FIG. 2).

In some examples, cryogenic stream 523, used to cool carbon dioxide separator 506 and water separator 504, may be sourced from one or more of the liquid nitrogen product stream 517, the liquid argon product stream 509, or oxygen product stream 511. Utilization of the cryogenically chilled streams as the cooling fluid in the beginning of the process increases the efficiency of the system, decreasing the parasitic load of water and carbon dioxide removal on the process. Further, when the oxygen is used in combustion, the oxygen is utilized at high temperatures, such that the cold would be otherwise wasted.

Heat exchanger 512 receives the dry ice stream 515 from carbon dioxide separator 506 via piping, and warms the liquid carbon dioxide stream against a hot fluid stream 521 from another process, such as a hot fluid from an oxy-fuel combustion process, generating a carbon dioxide fluid stream 525. Piping may send carbon dioxide fluid stream 525 to a carbon compression and purification unit (242 in FIG. 2). The compressed, purified carbon dioxide then may be suitably sequestered, stored, or used in a process.

Controller 530 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 530 and the system 500 may be implemented using any suitable combination of hardware and software.

A standalone startup cryogenic unit 522 is provided for startup of the process. Before startup, no cryogenic nitrogen, argon, or oxygen is available. As such, unit 522 is provided to provide stream 523 during startup.

It will be appreciated that blower 502 need not necessarily be included in system 500. In examples in which blower 502 is included, the blower need not necessarily be located upstream of water separator 504. Illustratively, in some examples, blower 502 is located between water separator 504 and carbon dioxide separator 506.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. A method for separating components of an air stream comprising water, carbon dioxide, nitrogen, argon, and oxygen in an oxy-fuel power generation system, the method comprising:
passing the air stream into an air separation unit comprising a water separator, a carbon dioxide separator, and a cryogenic separator;
condensing water out of the air stream against a first cryogenic fluid stream in the water separator, forming a dry air stream and an H2O stream;
condensing carbon dioxide out of the dry air stream against a second cryogenic fluid stream in the carbon dioxide separator, forming a CO2-barren air stream and a concentrated carbon dioxide stream;
separating the CO2-barren air stream into a nitrogen product stream, an argon product stream, and an oxygen product stream in the cryogenic separator;
using one or more of the nitrogen product stream, the argon product stream, and the oxygen product stream as the first cryogenic fluid stream, the second cryogenic fluid stream, or both after a startup period;
combusting the oxygen product stream in a combustor of the oxy-fuel power generation system; and
purifying and compressing the concentrated carbon dioxide stream in a carbon dioxide purification and compression unit.

2. The method of claim 1, wherein:
the water separator comprises a first train and a second train; and
the step of condensing water out of the air stream comprises:
condensing water out of the air stream as a first water ice in the first train,
condensing water out of the air stream as a second water ice in the second train,
while using the second train to condense water, heating the first train to melt the first water ice to form a first liquid water, draining the first liquid water from the first train,
while using the first train to condense water, heating the second train to melt the second water ice to form a second liquid water, and
draining the second liquid water from the second train.

3. The method of claim 1, wherein:
the carbon dioxide separator comprises a first train and a second train; and
the step of condensing carbon dioxide out of the dry air stream comprises:
condensing carbon dioxide out of the dry air stream as a first dry ice in the first train,
condensing carbon dioxide out of the dry air stream as a second dry ice in the second train,
while using the second train to condense carbon dioxide, heating the first train to melt or sublimate the first dry ice to form a first liquid carbon dioxide or a first gaseous carbon dioxide,
draining the first liquid carbon dioxide or the first gaseous carbon dioxide from the first train,
while using the first train to condense carbon dioxide, heating the second train to melt or sublimate the second dry ice to form a second liquid carbon dioxide or a second gaseous carbon dioxide, and
draining the second liquid carbon dioxide or the second gaseous carbon dioxide from the second train.

4. The method of claim 1, further comprising adding flue gas from a combustion process to the air stream passing into the air separation unit.

5. The method of claim 4, further comprising stripping NOx and SOx from the flue gas before adding the flue gas to the air stream.

6. The method of claim 4, further comprising stripping NOx and SOx from the flue gas via an acid gas stripper, after the step of condensing water out of the air stream and before the step of condensing carbon dioxide out of the dry air stream.

7. The method of claim 1, further comprising using a cryogenic coolant from a standalone cryogenic unit as the first cryogenic fluid stream, the second cryogenic fluid stream, or both during the startup period.

8. The method of claim 1, further comprising using the H2O stream as cooling water in a power generation system.

9. The method of claim 1, further comprising compressing the air stream before the step of condensing water, such that the carbon dioxide condenses as a liquid during the step of condensing carbon dioxide.

10. The method of claim 1, further comprising compressing the dry air stream before the step of condensing carbon dioxide, such that the carbon dioxide condenses as a liquid during the step of condensing carbon dioxide.

11. The method of claim 1, further comprising compressing the CO2-barren air stream into the cryogenic separator.

12. The method of claim 1, further comprising heating the H2O stream with a hot fluid from another process, the concentrated carbon dioxide stream, or both.

13. The method of claim 1, further comprising combining a carbon dioxide discharge product of the combustor with the concentrated carbon dioxide stream in the carbon dioxide purification and compression unit to produce a compressed carbon dioxide fluid.

14. The method of claim 13, further comprising recirculating a portion of the compressed carbon dioxide fluid as a working fluid for the oxy-fuel power generation system.

15. The method of claim 1, wherein:
the water separator comprises a screw conveyor comprising a screw; and
the step of condensing water out of the air stream comprises:
condensing water out of the air stream onto the screw as water ice,
sending the dry air stream out of the screw conveyor via a gas exit, and
rotating the screw such that the water ice is conveyed out of the screw conveyor via a solids exit.

16. The method of claim 1, wherein:
the carbon dioxide separator comprises a screw conveyor comprising a screw; and
the step of condensing carbon dioxide out of the dry air stream comprises:
condensing carbon dioxide out of the dry air stream onto the screw as dry ice,
sending the CO2-barren air stream out of the screw conveyor via a gas exit, and
rotating the screw such that the dry ice is conveyed out of the screw conveyor via a solids exit.

17. A method for separating components of an air stream comprising water, carbon dioxide, nitrogen, argon, and oxygen, the method comprising:
passing the air stream into an air separation unit comprising a water separator, a carbon dioxide separator, and a cryogenic separator;
condensing water out of the air stream against a first cryogenic fluid stream in the water separator, forming a dry air stream and an H2O stream;
condensing carbon dioxide out of the dry air stream against a second cryogenic fluid stream in the carbon dioxide separator, forming a CO2-barren air stream and a concentrated carbon dioxide stream;
separating the CO2-barren air stream into a nitrogen product stream, an argon product stream, and an oxygen product stream in the cryogenic separator; and
using one or more of the nitrogen product stream, the argon product stream, and the oxygen product stream as the first cryogenic fluid stream, the second cryogenic fluid stream, or both after a startup period.

18.-34. (canceled)

35. A system for separating components of an air stream comprising water, carbon dioxide, nitrogen, argon, and oxygen in an oxy-fuel power generation system, the system comprising:
an air separation unit to separate the air stream into components, the air separation unit comprising a water separator, a carbon dioxide separator, and a cryogenic separator;
a combustor coupled to the cryogenic separator; and
a carbon dioxide purification and compression unit coupled to the carbon dioxide separator;
wherein the water separator is configured to condense water out of the air stream by cooling via a cryogenic fluid stream, forming a dry air stream and an H2O stream;
wherein the carbon dioxide separator is configured to condense carbon dioxide out of the dry air stream by cooling via the cryogenic fluid stream, forming a CO2-barren air stream and a concentrated carbon dioxide stream;
wherein the cryogenic separator is configured to separate the CO2-barren air stream into a nitrogen product stream, an argon product stream, and an oxygen product stream, and to use one or more of the nitrogen product stream, the argon product stream, and the oxygen product stream as the cryogenic fluid stream after a startup period;
wherein the combustor is configured to combust the oxygen product stream; and
wherein the carbon dioxide purification and compression unit is configured to purify and compress the concentrated carbon dioxide stream.

36.-50. (canceled)

51. A system for separating components of an air stream comprising water, carbon dioxide, nitrogen, argon, and oxygen, the system comprising:
an air separation unit to separate the air stream into components, the air separation unit comprising a water separator, a carbon dioxide separator, and a cryogenic separator;
wherein the water separator is configured to condense water out of the air stream by cooling via a cryogenic fluid stream, forming a dry air stream and an H2O stream;
wherein the carbon dioxide separator is configured to condense carbon dioxide out of the dry air stream by cooling via the cryogenic fluid stream, forming a CO2-barren air stream and a concentrated carbon dioxide stream; and
wherein the cryogenic separator is configured to separate the CO2-barren air stream into a nitrogen product stream, an argon product stream, and an oxygen product stream, and to use one or more of the nitrogen product stream, the argon product stream, and the oxygen product stream as the cryogenic fluid stream after a startup period.

52.-68. (canceled)
